(19) United States
(12) Patent Application Publication
(10) Pub. No.: US 2006/0277487 A1
(43) Pub. Date: Dec. 7, 2006

(54) Project manager system and method

(76) Inventors: Jay H. Poulsen, Garland, UT (US); Jerald D. Poulsen, Garland, UT (US); Nathan R. Marigoni, Hooper, UT (US); Neil R. Wyler, Layton, UT (US)

Correspondence Address: STOEL RIVES LLP - SLC, 201 SOUTH MAIN STREET, ONE UTAH CENTER, SALT LAKE CITY, UT, 84111, US

(21) Appl. No.: 11/405,818

(22) Filed: Apr. 18, 2006

Related U.S. Application Data
(60) Provisional application No. 60/672,268, filed on Apr. 18, 2005.

(51) Int. Cl. G06F 19/00

(52) U.S. Cl. 715/772; 700/100

(57) ABSTRACT

A Network Diagram Application arranges multiple activities relative to a timeline to improve user visualization, facilitate editing, and provide a user-friendly interface for linking activities. The Network Diagram Application enables creation of store points which reflect the state of activities at that point in time. Store points may be accessed to compare how activities have changed over time. A Critical Path Method Checker reviews the activities and their relationships to determine if all information is within requisite parameters to avoid problems during the project.

### RELATED APPLICATIONS

This application claims priority to U.S. Patent Application No. 60/672,268 filed on Apr. 18, 2005, and titled “Project Manager System and Method” which is hereby incorporated by reference.

### TECHNICAL FIELD

This invention relates to management operations and techniques to efficiently supervise a complex project including numerous tasks.

### BRIEF DESCRIPTION OF THE DRAWINGS

A more particular description of the invention briefly described above will be rendered by reference to the appended drawings. Understanding that these drawings only provide information concerning typical embodiments of the invention and are not therefore to be considered limiting of its scope, the invention will be described and explained with additional specificity and detail through the use of the accompanying drawings, in which:

FIG. 1 illustrates a block diagram of a computer system.

FIG. 2 illustrates an embodiment of a network diagram.

FIG. 3 illustrates an alternative embodiment of a network diagram.

FIG. 4 illustrates another embodiment of a network diagram.

FIG. 5 illustrates a portion of a network diagram.

FIG. 6 illustrates another portion of a network diagram.

FIG. 7 illustrates a screen view of text editing of a network diagram.

FIG. 8 is a user interface inputting parameters for use by a CPM Checker.

FIG. 9 illustrates a screen view of a violation in a network diagram.

FIG. 10 illustrates an embodiment of a review explanations interface.

FIG. 11 illustrates another screen view of a violation in a network diagram.

FIG. 12 illustrates yet another screen view of a violation in a network diagram.

FIG. 13 illustrates an embodiment of a comparison setup interface.

FIG. 14 illustrates an embodiment of a create store point interface.

FIG. 15 illustrates an embodiment of an update store point interface.

FIG. 16 illustrates an embodiment of a comparison window.

FIG. 17 illustrates an alternative embodiment of a comparison window.

FIG. 18 illustrates an example of a lag-to interface.

FIG. 19 illustrates an embodiment of a lag window.

FIG. 20 illustrates an embodiment of an activity editor format interface.

FIG. 21 illustrates an embodiment of an activity editor.

FIG. 22 illustrates an alternative embodiment of an activity editor.

### DETAILED DESCRIPTION OF PREFERRED EMBODIMENTS

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in the Figures, is not intended to limit the scope of the invention, as claimed, but is merely representative of presently preferred embodiments of the invention. In particular, an “embodiment” of the invention may be a system, an article of manufacture, a method, the product of a process, and/or a signal which configures a computer random access memory, disk, CD, DVD, or other computer-readable media.

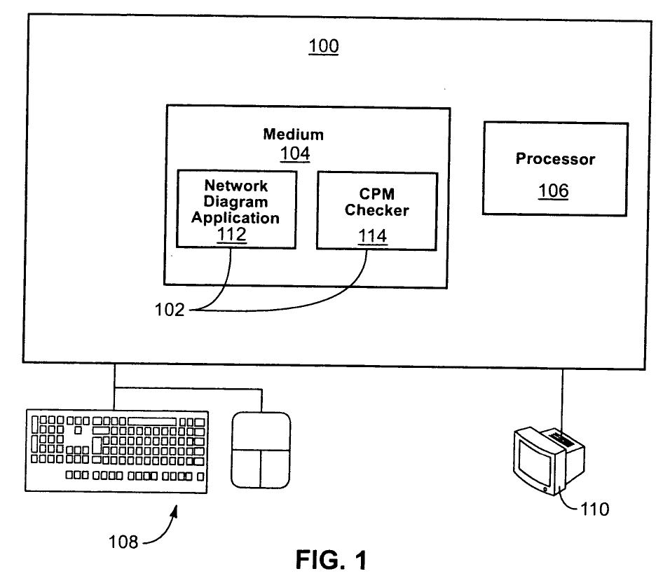

Referring to FIG. 1, a block diagram of a computer system 100 is shown. The present invention may be implemented within a general purpose computer, a program specific computer, or other suitable hardware with processing capability. A system includes applications 102 that may be resident on a computer readable medium 104 and operated by a processor 106. The processor 106 may include a general purpose device, such as a 80.times.86, Pentium (mark of Intel), 680.times.0, or other “off-the-shelf” microprocessor. The processor 106 may include a special purpose processing device, such as an ASIC, PAL, PLA, PLD, Field Programmable Gate Array, or other customized or programmable device. The computer readable medium 104 may include static RAM, dynamic RAM, flash memory, ROM, CD-ROM, disk, tape, magnetic, optical, or other computer storage medium. The computer readable medium 104 tangibly embodies a program, functions, and/or instructions that are executable by computer system 100.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

The computer system 100 further includes various input devices 108 and/or output devices 110. The input device(s) 108 may include a keyboard, mouse, touch screen, light pen, tablet, microphone, sensor, or other hardware with accompanying firmware and/or software. The output device(s) 110 may include a monitor or other display, printer, speech or text synthesizer, switch, signal line, or other hardware with accompanying firmware and/or software.

The computer system 100 may include communications or networking software, such as the software available from Novell, Microsoft, Artisoft, and other vendors, and may operate using TCP/IP, SPX, IPX, and other protocols over twisted pair, coaxial, or optical fiber cables, telephone lines, satellites, microwave relays, modulated AC power lines, physical media transfer, and/or other data transmission “wires” known to those of skill in the art. The network may encompass smaller networks and/or be connectable to other networks through a gateway or similar mechanism.

The computer system 100 may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, random access memory, flash memory, and other computer system storage devices. The physical configuration represents data and instructions which cause the computer system to operate in a specific and predefined manner as described herein.

The computer system 100 includes a Network Diagram Application 112 that may be stored on the computer readable medium 104. The Network Diagram Application 112 provides various functions to illustrate multiple activities involved in a project. The Network Diagram Application 112 arranges activities vertically and extends them horizontally along a timeline with labeling to enhance user visualization and understanding. The activities may be edited and manipulated through point and clicking techniques commonly found in operating systems. The Network Diagram Application 112 may be utilized for commercial construction projects, although one of skill in the art will recognize that the Application 112 has utility for various complex projects involving a number of activities.

The computer system 100 further includes a CPM (Critical Path Method) Checker 114 which is an application that checks a schedule for compliance with certain CPM criteria. A critical path is a path or paths through interrelated activities that have zero float. The critical path includes the activities that if delayed or changed will affect the overall end date of the schedule. CPM criteria preserve the integrity of a critical path. The evolution of computer aided scheduling has led to a number of situations in which proper CPM scheduling methods are either misused, or abused. These improper methods are then institutionalized, and the craft of scheduling suffers. Poorly developed schedules can create problems both during the project, and afterwards. In subsequent legal proceedings, the schedule and supporting documents are often used as evidence. A poorly developed or maintained schedule can cause serious financial and professional problems for a project manager. The CPM Checker 114 assists a scheduler in avoiding some of these approaches that do not meet CPM criteria.

CPM Checker 114 evaluates the information input by a user and assists the user in proper usage of a CPM. The user first determines what the criteria for proper CPM entails. This would be done by entering some information from a contract specification typically given to a user for any project with which they may be involved. In the construction industry, the CPM Checker 114 may be set to typical tolerances for a commercial construction project.

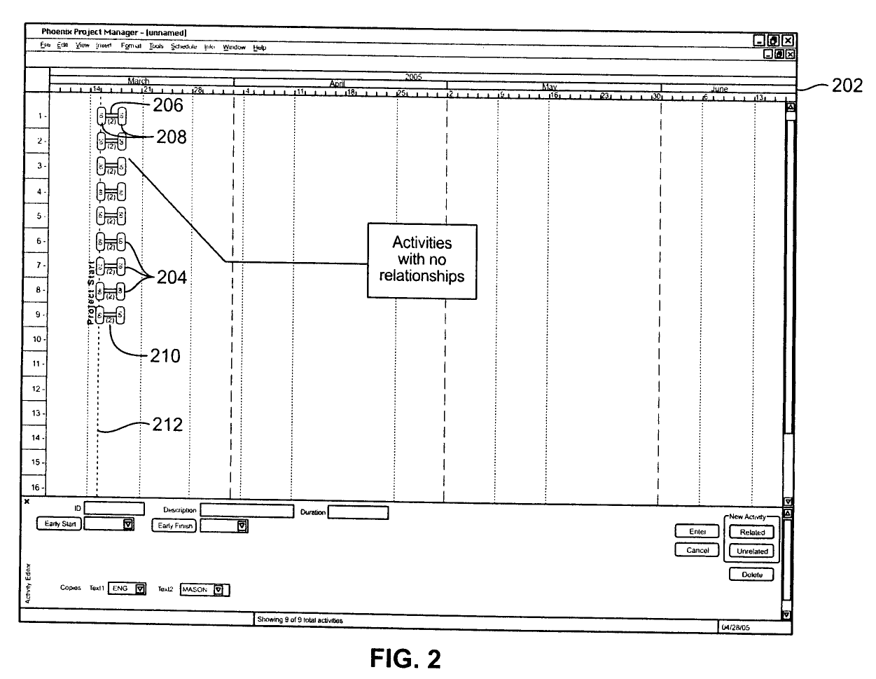

Referring to FIG. 2, a screen display of an example of a network diagram 200 is shown that represents a schedule. The network diagram 200 includes a timeline 202 that is illustrated as a horizontal bar that may display days, weeks, and months in a calendar year. The network diagram 200 also includes a plurality of activities 204 that each include activity bars 206 and start and finish tags 208. The length of the activity bar 206 may indicate the duration of the activity 204. The activity bar length is viewed in relation to the timeline 202 to gauge duration. Each start and finish tag 208 may include an activity number or other alphanumeric identification to identify the activity. The activity number is shown as being the same in the start and finish tags. An activity 204 is a scheduling unit that defines specific work to be done over a discrete period of time. An activity 204 is a basic unit of a schedule.

The activities 204 are discussed herein in relation to work units. A work unit is a chosen unit of time, i.e., minutes, hours, days, months, years, etc. In the illustrated examples herein, work units are days, which is common in the construction industry. Sometimes it becomes necessary to re-engineer a schedule to use a new default work unit, whether switching from days to hours, or weeks to months. The Network Diagram Application provides a change work unit feature to allow a user to quickly and accurately change hours into days, years to hours, and the like. The changes are reflected throughout the network diagram 200. When converting, fractions of the new base unit may be used if necessary. Most scheduling software supports various work units, but when it comes time to switch, either to get a particular view of a project, or to permanently change the work context, this option has not been available. The present invention supports changing work units to both larger and smaller units in existing schedules, allowing this flexibility.

The activities 204 extend relative to the timeline 202 to establish a time-based relationship. The activities 204 may also include a duration indicator 210 which may be embodied as a number in parenthesis. The duration indicator 210 indicates the amount of time that an activity will require from start to finish. The duration indicator 210 may track time as a relation to a current work unit, i.e., minutes, hours, days, months, years, etc. Each start and finish tag 208 for an activity 204 may include corresponding activity identifications. As illustrated, the activity identifications are listed as 10 through 90.

Activities 204 are entered by users through any number of conventional input devices. Activities 204 may be edited and manipulated by selecting an activity 204 and then entering new data. Activities 204 may be moved throughout the network diagram 200 by use of drag or drop techniques. Selection of an entire activity 204 allows a user to move the whole activity to another location within the diagram. Selection of an entire activity 204 may be accomplished by a double click or a click and capture technique. Vertical placement of an activity 204 may be done to enhance user visualization, whereas horizontal placement of an activity 204 is to illustrate a time relationship. Selection of only a start or finish tag 208 allows a user to move and extend or shorten the duration of an activity bar 206.

The listed activities 204 are not shown with relationships between one another. Typically, a project will have a number of relationships between each activity. The illustrated activities 204 are illustrated as proceeding in parallel to one another, which is uncommon in large-scale complex projects. The illustrated activities 204 further are shown starting and finishing on the same times. The network diagram 200 further includes a project start line 212 which may be embodied as a vertical dashed line that indicates a start time for the project. As shown, all activities 204 are beginning on the project start line 212 and finish at the same time.

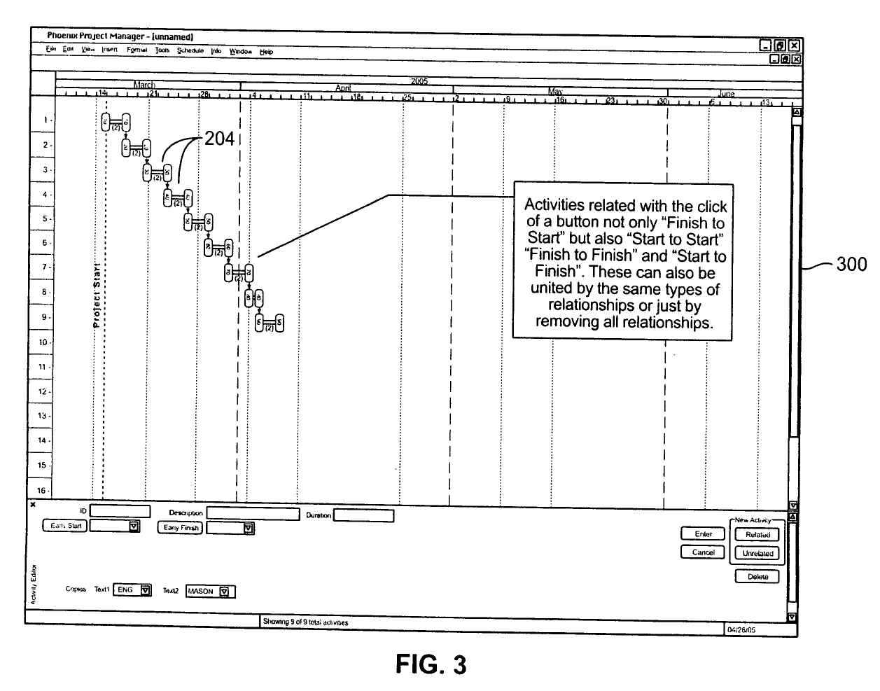

Referring to FIG. 3, an alternative network diagram 300 is shown which includes the activities of FIG. 2. The activities 204 are shown linked to one another sequentially in finish-to-start relationships. Relationships represent the interdependency or logic between activities. A relationship may be one of four types: start-to-start, finish-to-start, finish-to-finish, and start-to-finish. The finish-to-start relationship is the most common in schedules, and frequently, a schedule may consist entirely of these relationships.

When creating a large group of activities, it is beneficial to be able to link these activities with a particular type of relationship from beginning to end. The Network Diagram Application allows for multiple links to create a chain of finish-to-start relationships. Links may be created between finish-to-start tags 208 by selecting the desired tags in succession or through other desired input. The Network Diagram Application allows a user to select activities and then automatically link adjacent finish and start tags 208 based on proximity. The Network Diagram Application may also allow a user to select linked activities and unlink all selected activities based on an input option.

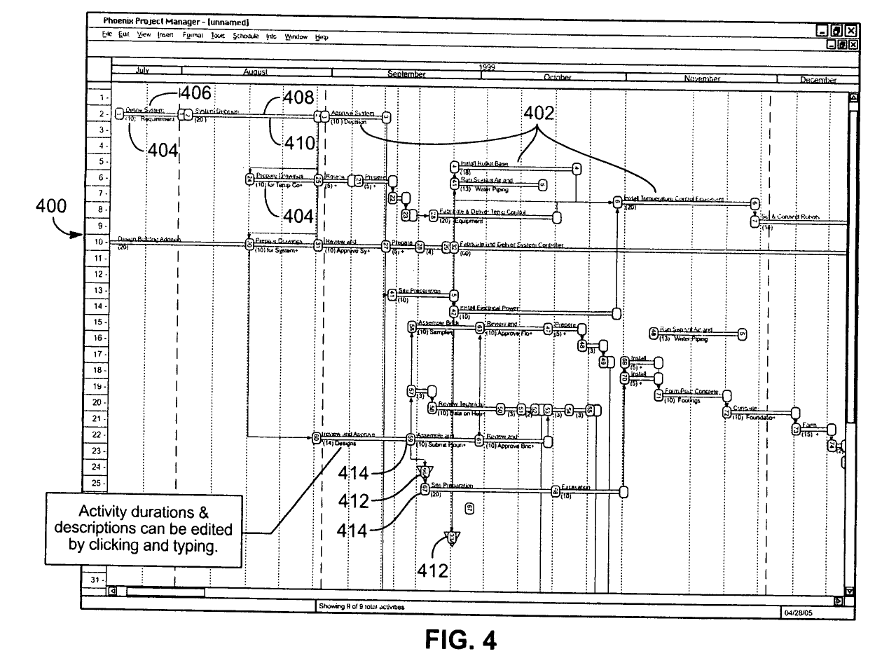

Referring to FIG. 4, a network diagram 400 is shown illustrating various activities 402 linked to one another to form relationships. The network diagram, in addition to being a far more compact and efficient method of visualizing and developing a schedule, also illustrates the logic of a schedule far more effectively than bar diagrams, as it is built upon an Arrow Diagram Method (ADM) logic diagrams. Bar charts do not allow for compact display and development provided by the network diagrams disclosed herein. A network diagram is built using a double node system (i.e., start and finish tags) that alleviate the problems of earlier system's inability to make significant changes or modifications without renumbering or restructuring of a schedule.

The Network Diagram Application implements a What-You-See-Is-What-You-Get (WYSIWYG) paradigm. While previous network diagrams required blind scheduling, and significant post-production visualization work, the Network Diagram Application allows the user to develop a schedule using a network diagram in real-time, adding all visual features necessary to effectively communicate the project logic. The visual result is what the project scheduler sees on the scheduler's screen. The Network Diagram includes drag and drop line assignment, activity and relationship drawing, and click and type ease to thereby create a truly WYSIWYG interface.

Each activity 402, in addition to an activity duration 404, may include an activity description 406. The activity description 406 may be listed above and/or below a corresponding activity bar 408. The activity description 406 may include a few words of text to readily identify the activity to the user. Both the activity description 406 and the activity durations 404 may be edited by clicking and typing. An activity bar 408 may further include a progress meter 410 which is indicated by an internal fill. As the activity bar 408 fills from left to right, the progress is measured.

The network diagram 400 further illustrates milestones 412 which are zero duration events. The milestones 412 indicate a noted level of progress in the project and may be linked to start and finish tags 414. Milestones 412 may also be identified as start and stop milestones.

The Network Diagram Application allows for improved use of space by vertically arranging multiple activities. In this manner, the schedule is condensed to insert activities into a screen portion where real estate is not being used. This is a more compact technique for developing and visualizing a schedule. Using the WYSIWYG paradigm, a user can insert activities directly into a schedule. A user can manipulate an activity through pointing and clicking to alter duration, create or alter links, and edit description. A modified network diagram provides instant feedback to illustrate changes that have been made.

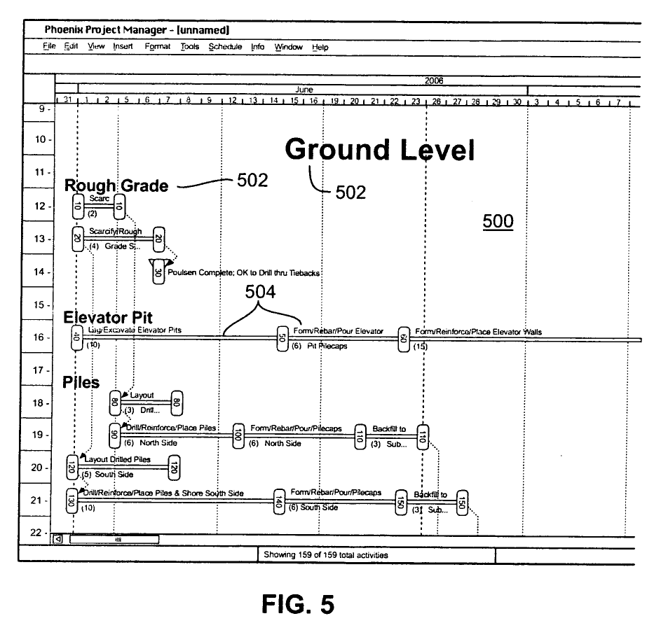

Referring to FIG. 5, a portion of an alternative embodiment of a network diagram 500 is shown. To facilitate user comprehension and visualization, text identifiers 502 may be inserted to identify a certain portion of a project. Thus, “GROUND LEVEL” indicates a portion of the project with “Rough Grade,” “Elevator Pit,” and “Piles” indicating subsets of the portion. Activities 504 adjacent the identifiers are included within the respective subset. As illustrated, completion of the activity 20 is linked to a milestone 30. Completion of activity 10 is linked to the start of activity 80, which is in turn linked to the start of activity 90. Start of activity 20 is linked to the start of activity 120, which is in turn linked to the start of activity 130. As can be appreciated, a project may require various relationships between the start and finish of activities.

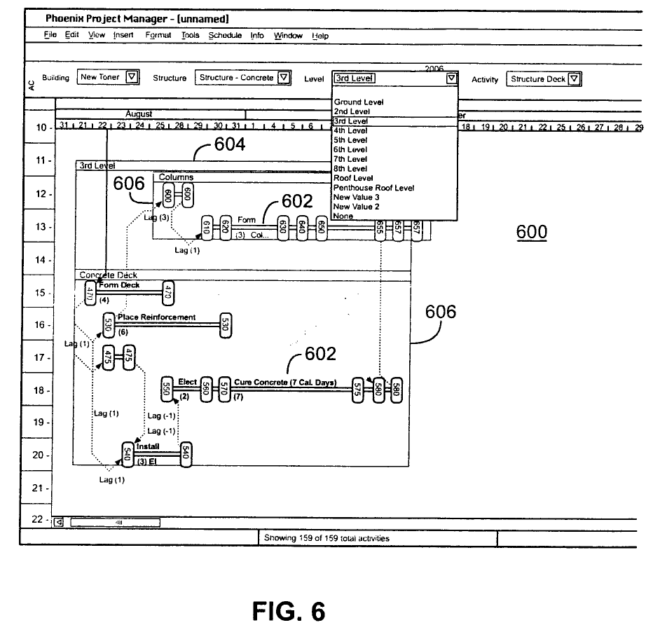

Referring to FIG. 6, an alternative network diagram 600 is shown. The network diagram 600 may have activities 602 grouped into a set 604 which is identified as “3^{rd} Level.” The set 604 may further include subsets 606 which are identified as “Columns” and “Concrete Deck.” As can be appreciated, depending on the magnification view, a network diagram may extend beyond a screen view. By selecting the appropriate set, the screen illustrates the requested set of activities. Selection may be through a scroll down menu as illustrated. Thus, a user may view one level of construction and then select an alternative level of construction to view that corresponding set of activities. This effectively reduces excessive scrolling that would otherwise be required in a large network diagram.

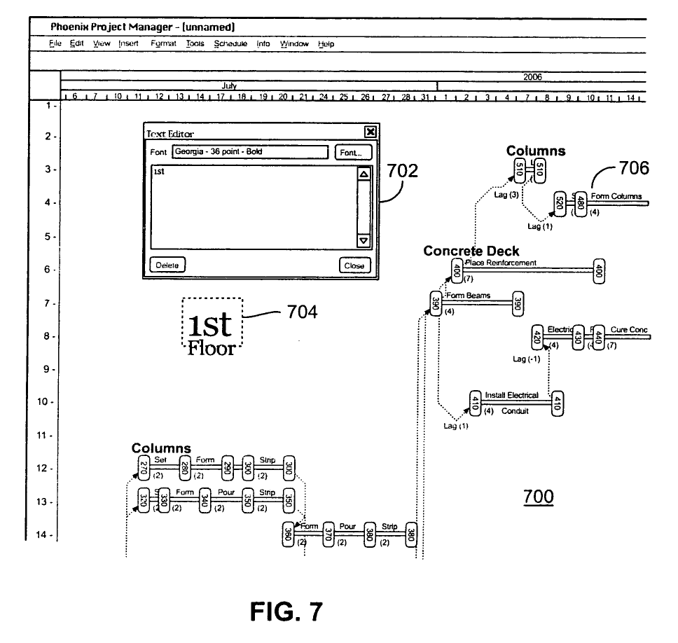

Referring to FIG. 7, an alternative network diagram 700 is shown. The network diagram 700 illustrates a text editor box 702 which may be generated upon clicking or otherwise selecting text, such as an identifier 704 or an activity description 706. In the illustrated example, the identifier “1^{st}” has been selected which allows for manipulation of text and font. The identifier 704 may further be selected and moved as desired.

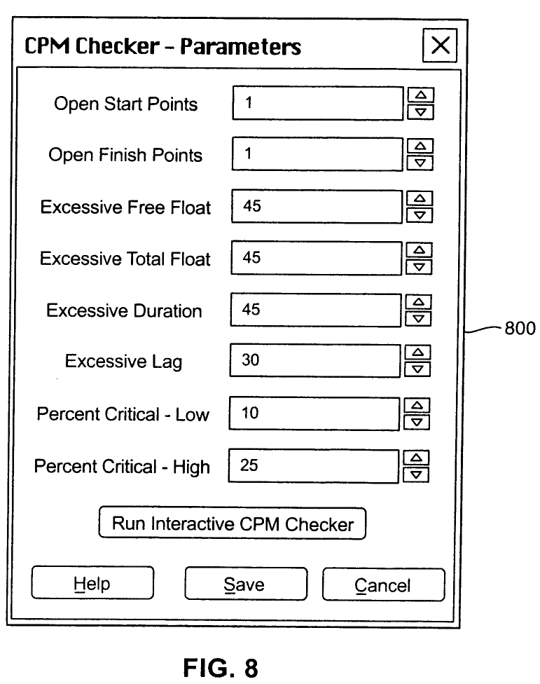

Referring to FIG. 8, an embodiment of a user interface 800 for inputting parameters is shown for use by the CPM Checker. The CPM Checker evaluates the parameters and reviews each element of a schedule against the parameters. The CPM Checker alerts the user to errors or potential areas of concern. In this manner, the CPM Checker ensures that a schedule's logic complies with a set of rules. The CPM Checker further serves as a tutoring application to assist a user in generating a schedule. One input is for the number of Open Start Points to be used in a schedule. Open Start Points are defined as an activity with no predecessor. Another input is for Open Finish Points to be used. Open Finish Points are activities with no successor.

Another input is for the number of Excessive Floats. The float of each activity is checked to ensure it has a reasonable duration. A float may be a total float or a free float. The total float is the number of days, or other current work unit, i.e., hours, minutes, years, etc., an activity can be delayed without affecting the overall schedule finish. Free float is the number of days, or current work unit, an activity can be delayed without affecting its successor's early start or early finish. Early start or early finish is the earliest an activity is allowed to start or finish without affecting the overall finish date. Similarly, late start and late finish is the latest an activity is allowed to start or finish without affecting the overall finish date. The Excessive Float is an upper bound. In the illustrated example, no activity is to have a float of more than 45 days.

The Excessive Duration is also checked to see if the duration of the activity itself is reasonable. The Excessive Duration is an upper bound. In the illustrated example, no activity is to have a duration of more than 45 days. If an activity exceeds this duration, the activity will be separated into multiple activities. Excessive Lags are checked to ensure that lags have a reasonable duration. This is an upper bound as well.

The interface 800 further prompts for upper and lower bounds for a Percent of Critical Activities. This reflects the number of activities determined to be critical as a percentage of the total number of activities. The input provides a range from a low percentage to a high percentage. The interface 800 may also prompt for a Number of Constraints. This parameter is the maximum number of activities with applied constraints. A constraint is a restriction on an activity that dictates the start or finish date of the activity without regard to the logic of the scheduling algorithm. An example of a constraint is requiring that an activity not begin until a certain day. The CPM Checker identifies when an excessive number of constraints has been entered as it overly burdens a schedule.

After input entry and preparation of a network diagram, the CPM Checker may be initiated to traverse the schedule reflected in the network diagram. The CPM Checker reviews for violations and prompts for user interaction on each violation. The CPM Checker not only points out the shortcomings of the schedule's logic, but describes the problem and suggests possible solutions to resolve the issue. This not only adds extra assurance to the schedules validity but also facilitates the mastering of scheduling techniques.

If the user is unable to manipulate the attributes of activities to resolve the issue, a user may be presented with choices for proceeding, such as “Recheck,” “Explain,” “Skip,” or “Stop.” After evaluating the schedule, the CPM Checker produces a brief report of criteria which includes any unresolved issues and explanations to areas of the schedule that are exempt from the CPM Checker evaluation. After a schedule has successfully undergone the CPM Checker process, a symbol may be placed in plain view on-screen and on every page of printouts.

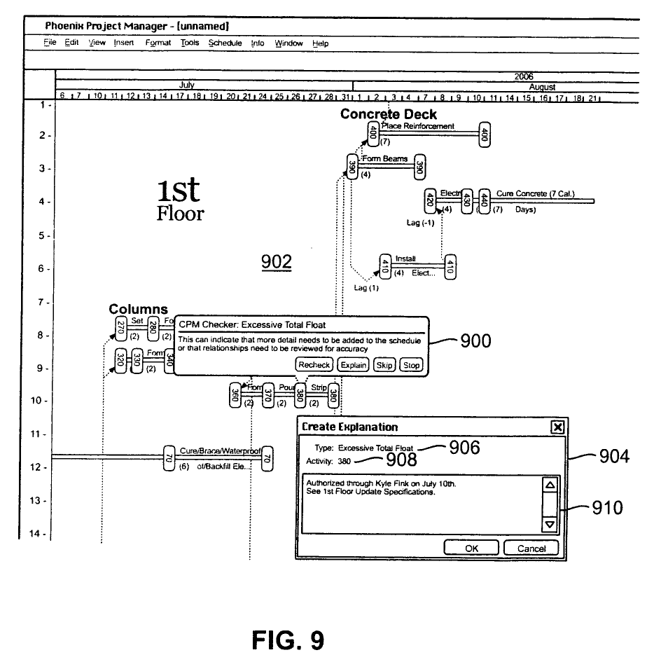

Referring to FIG. 9, an example of a violation message 900 is shown relative to a network diagram 902. The violation message 900 may be embodied as a “balloon” that points to an activity or any element in a network diagram. In this example, the violation message 900 indicates that there is an excessive total float for activity 380. The user may respond to the violation by selecting Recheck, Explain, Skip, or Stop. If “Recheck” is selected, the CPM Checker reruns the analysis. If “Explain” is selected, the user is prompted to provide an explanation of why to ignore the improper criteria. When “Skip” is selected, the CPM Checker passes over the violation and picks it up again next time the user runs CPM Checker. If “Stop” is selected, the CPM Checker terminates its review.

In the illustrated example, the user has selected the Explain option which generates a create explanation interface 904. The interface 904 identifies the violation 906, the activity 908, and allows a user to enter a text explanation 910. The interface 904 allows a user to exit the interface 904 by selecting “OK” to indicate completion of the explanation or “Cancel” to indicate removal of the explanation.

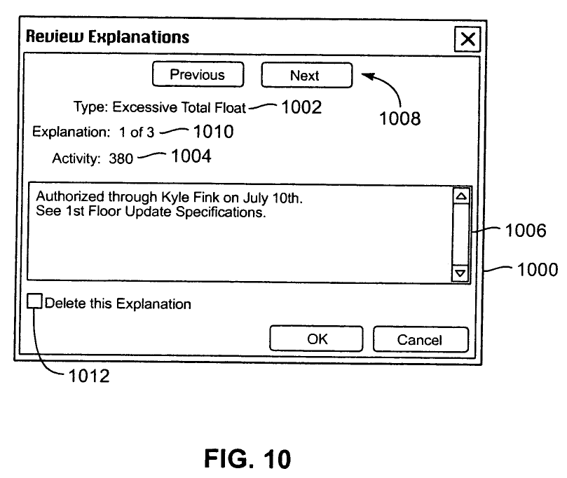

Referring to FIG. 10, an example of a review explanations interface 1000 is shown that is generated by the CPM Checker. The interface 1000 provides a method for reviewing explanations that have been generated for each violation. The interface 1000 illustrates the type of violation 1002, which in this example is the excessive total float of FIG. 9. The activity 1004 is identified as being number 380. The explanation 1006 is then provided, which is associated with this particular violation. Previous and Next options 1008 are provided to allow a user to scroll through explanations. The interface 1000 may also illustrate the current number 1010 of the explanation. The interface 1000 may also provide a delete option 1012 to permanently remove the currently displayed explanation. Based on the explanation, the violation may be tolerated upon supervisory or peer review. If not, a user may need to manipulate a network diagram.

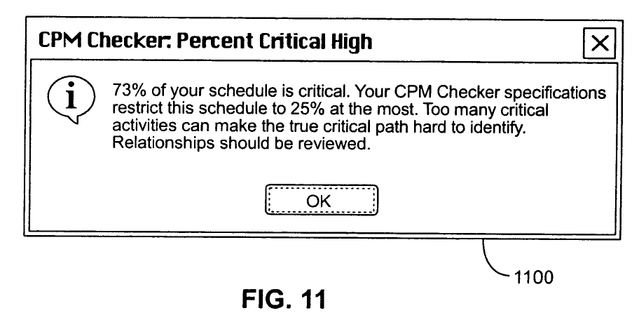

Referring to FIG. 11, an example of a violation warning 1100 is shown that is generated by the CPM Checker. The warning 1100 alerts the user to an excessive number of activities that are identified as being critical. The Network Diagram Application allows activities to be identified as critical to the progress of a project. The Network Diagram Application then generates a critical path which identifies a succession of linked activities that are critical to the project. Identifying too many activities as critical makes it difficult to correctly generate a critical path. The user may correct critical activity identification to remove this violation.

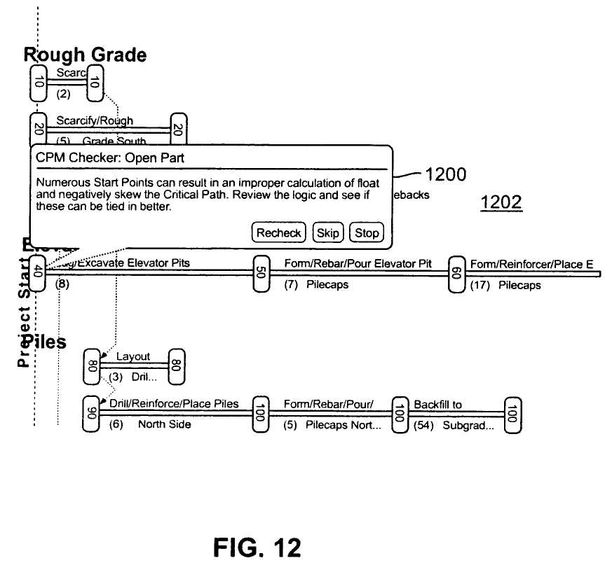

Referring to FIG. 12, another example of a violation message 1200 is shown relative to a network diagram 1202. The violation message 1200 is indicated by the CPM Checker as having an excessive number of open start points. The violation message 1200 is associated with activity 48 on the network diagram 1202.

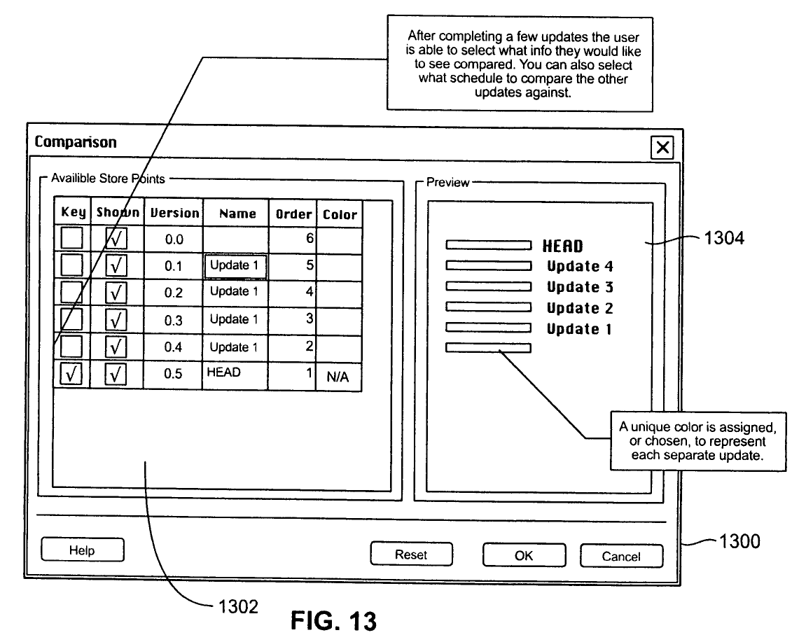

Referring to FIG. 13, an embodiment of a comparison setup interface 1300 is shown. The Network Diagram Application provides comparisons which utilize previous schedule information (dates, durations, cost, etc.) to show how the schedule has changed over time. Comparison functionality allows the user to define and save an unlimited number of comparisons, while adjusting the display of information to achieve maximum readability. The Comparison Setup Window 1300 includes a display 1302 of store points. Store points represent a snapshot of a schedule in time. A store point indicates the estimated and actual durations of activities at that point in time. The generation of store points facilitates the generation of a comparison of a schedule at a plurality of times. In this manner, a user can review a comparison and determine how a schedule is developing over time.

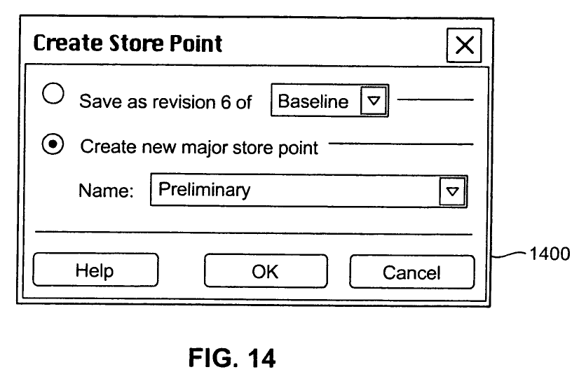

Referring to FIG. 14, an embodiment of a create store point interface 1400 is shown. The create store point interface 1400 may prompt to determine if the store point is to overwrite an existing store point or will be saved as a new store point. The interface 1400 further prompts for name of the created store point. After initial date entry, the interface then prompts for a date to be associated with the store point. A storepoint can be saved through the interface 1400, by a File>Save store point operation, or by having the program automatically save store points during designated operations.

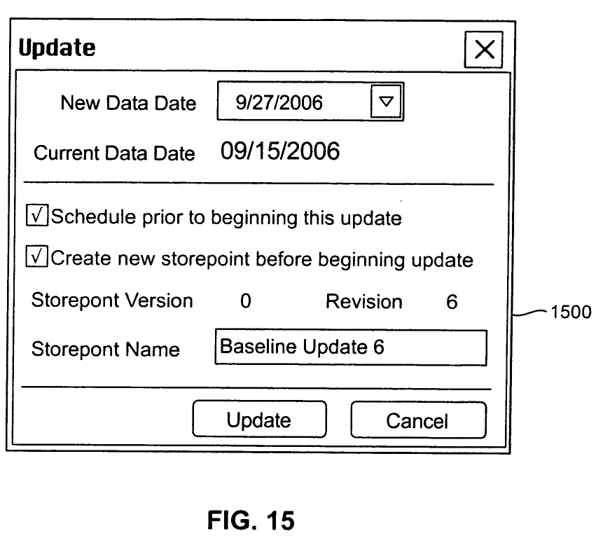

Referring to FIG. 15, an embodiment of an update store point interface 1500 is shown. The interface 1500 prompts a user for a new date to be associated with the store point and may identify the current associated date. The interface 1500 may provide the options of including the schedule prior to beginning the current update and creating a new store point before beginning the update.

Referring again to FIG. 13, the display 1302 of store points illustrates store points with associated version numbers, names, order of presentation, and color. The preview 1304 illustrates how the activities will be displayed in order and in color within a comparison window. In this manner, the comparison setup interface 1300 allows for customization of color presentation and order of presenting set points.

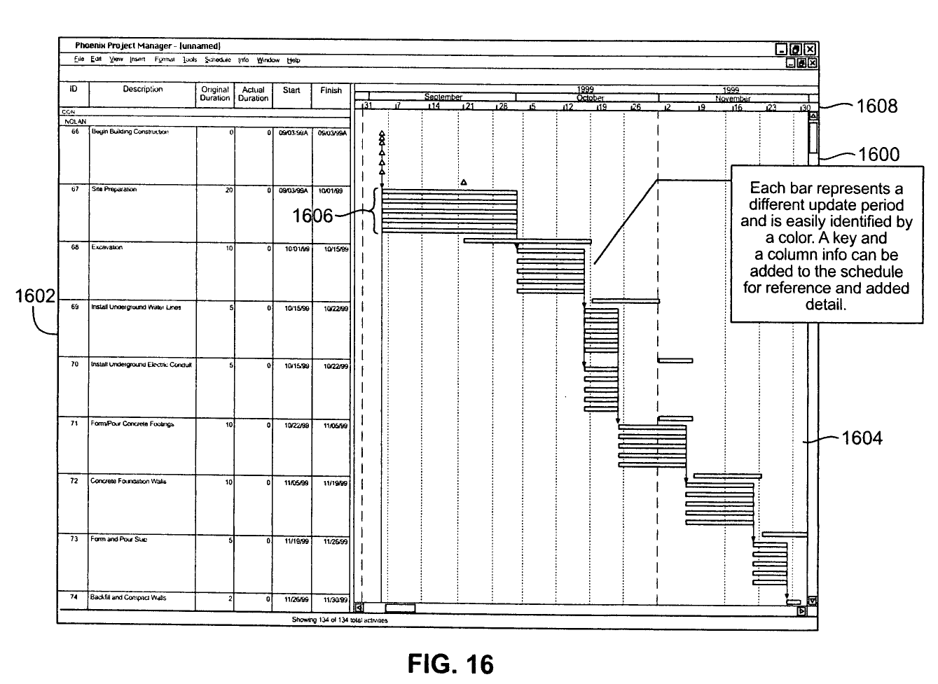

Referring to FIG. 16, an embodiment of a comparison window 1600 is shown. The comparison window 1600 provides for unlimited comparisons of schedule data from as many store points as needed. The comparison window 1600 may be viewed onscreen or provided as a printout to view the trend of activities completed early or slipping behind. The comparison window 1600 provides an activity list 1602 of all the activities within a network diagram. The comparison window 1600 further includes a bar chart 1604 that displays different update periods for each activity. For example, bars 1606 all identify an activity and its estimated start, completion, and finish over different set points. The bars 1606 may be displayed in relation to a timeline 1608. The different bars may be identified with colors corresponding to set points.

As shown, the first five bars 1606 have the same start, duration, and finish. However, the last bar indicates the start and finish times have been delayed. Differences in additional activities can also be noted. As can be expected, a delay in an activity creates delays in subsequently linked activities.

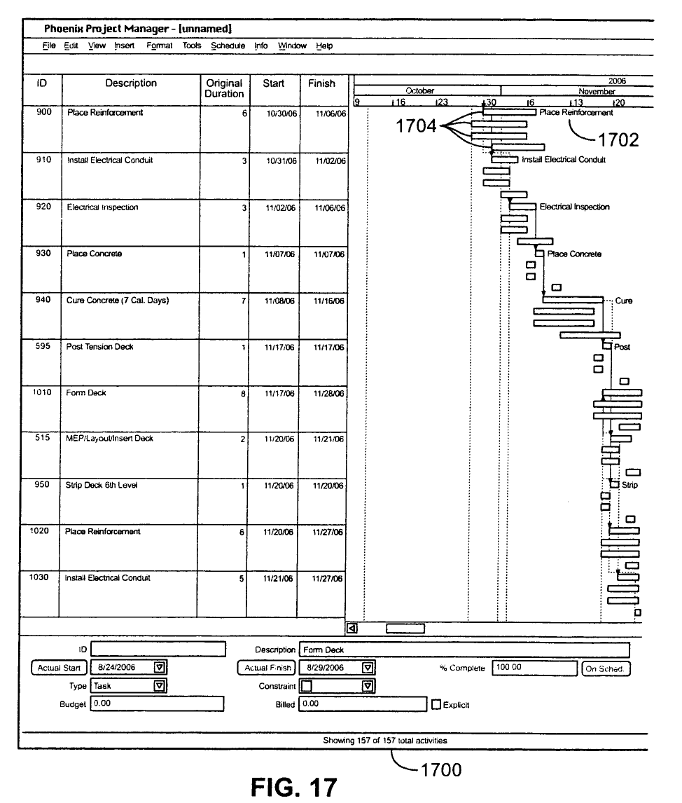

Referring to FIG. 17, an alternative view of a comparison window 1700 is illustrated. The comparison window 1700 provides labels 1702 for each series of bars 1704 corresponding to an activity. As can be appreciated by one of skill in the art, additional detail may be added to the comparison window for reference. Thus, the comparison windows 1600, 1700 are only provided as examples. The comparison window is a useful tool for analyzing how a project is going and identifying trouble spots. The comparison window is beneficial in a claims situation when the performance of a single activity through a project lifecycle is in question. Having the ability to compare, for example, 2000 activities' progress over the period of 20 updates is quite useful in a litigation scenario. The comparison window may allow for different views to select one activity and filter out the remaining activities. In this way, a user may view all updates corresponding to one crucial activity.

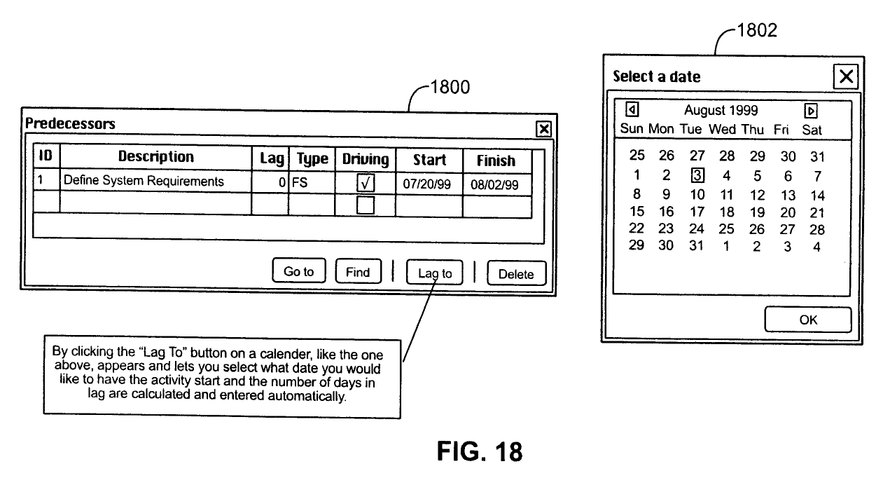

Referring to FIG. 18, a lag-to interface 1800 is shown that enables lag-to functionality. Lag represents an introduced delay in an activity that can also affect the relationship between two activities. For instance, a first activity is to begin on a first date. The first activity has a certain duration which will extend over a certain number of work days. However, a certain number of holidays (non-work days) will also exist in the calendar. The non-work days may be entered by a user for a calendar year. The non-work days create a certain amount of lag in an activity's duration which then delays the start date for a linked second activity. Calculating the lag for the first and subsequent activities can be inconvenient, and the interface 1800 provides this function.

The interface 1800 may identify an activity by identification number and by description. The interface 1800 may provide a start date and a projected finish date based on activity duration and any lag caused by non-work days. The interface 1800 further lists the Lag, such as a number of days. By selecting the “Lag to” option, a calendar 1802 appears, and the user has the option of selecting which date for the activity start date. The number of lag days are automatically calculated and entered. Lag can also be assigned to a relationship between two activities to delay the start or finish of the successor activity or milestone.

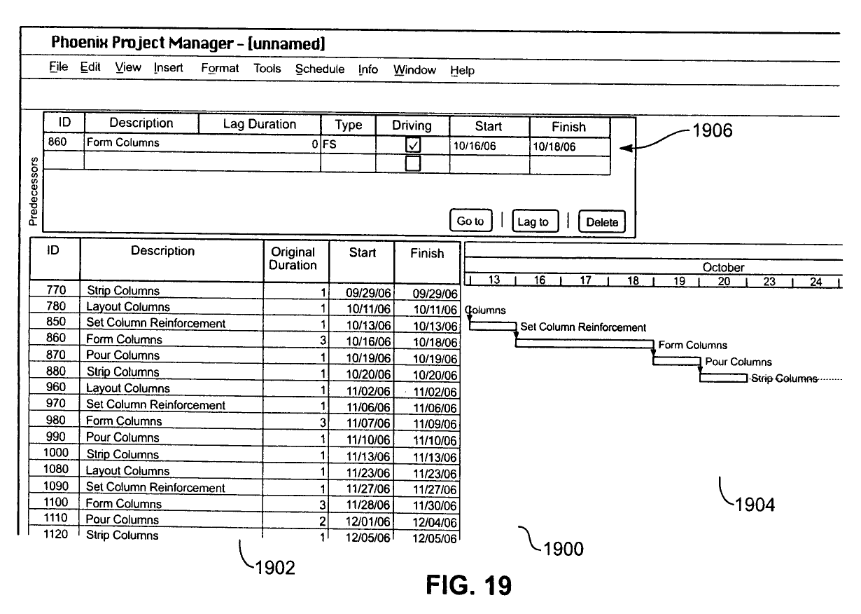

Referring to FIG. 19, an embodiment of a lag window 1900 is shown. The lag window 1900 may include an activity list 1902 which includes activity identification numbers, activity descriptions, and original activity durations. The lag window 1900 further displays calculated start and finish dates based on work and non-work days. Although not shown, the lag window 1900 may further illustrate the number of lag days for each activity. The lag window 1900 may further include a bar chart 1904 which illustrates bars corresponding to each activity. Each bar may be identified by number and/or description. The bars are linked to one another to illustrate relationships. The bars are further shown in relation to a timeline to effectively illustrate a duration which includes any lag. The lag window 1900 may further include a lag-to interface 1906 similar to that described in FIG. 18. The lag-to interface 1906 allows selection of any listed activity in activity list 1902 and a report of the start, finish, duration, and lag is provided.

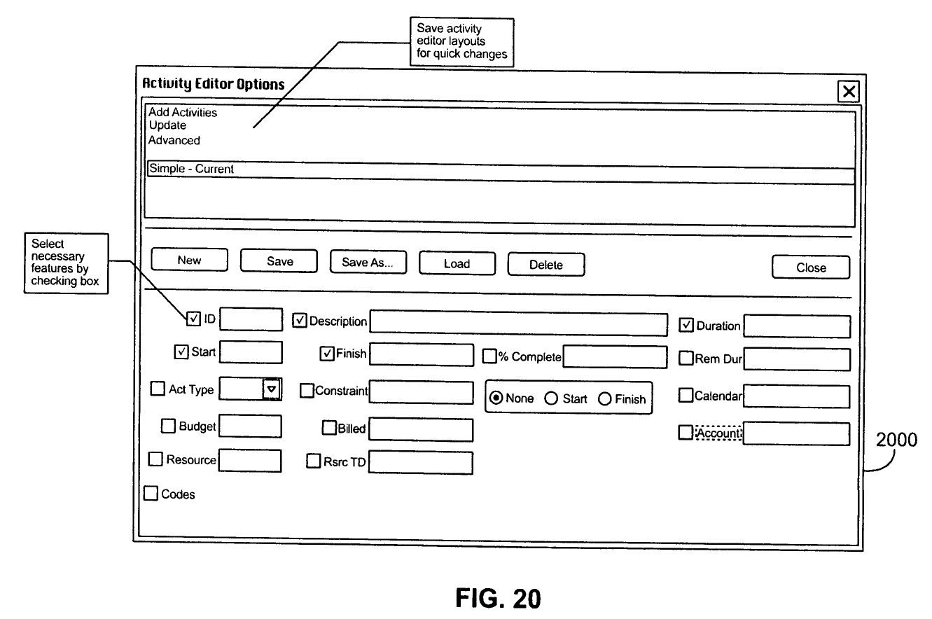

Referring to FIG. 20, an activity editor format interface 2000 is shown which allows users to adjust the level of complexity of an activity editor presented to them when scheduling. In this manner, an activity editor may be customized. The interface 2000 also allows a user to preserve screen space by eliminating unused options from a presented network diagram. In the interface 2000, a user simply “checks off” whatever information the user would or would not like to see/edit. The user then saves the input as a profile with a unique name. An unlimited number of profiles can be saved for various configurations of the activity editor, and a user may switch between profiles on the fly. This allows a user to have must-have options available while hiding the clutter, and facilitates access to an advanced option, when necessary.

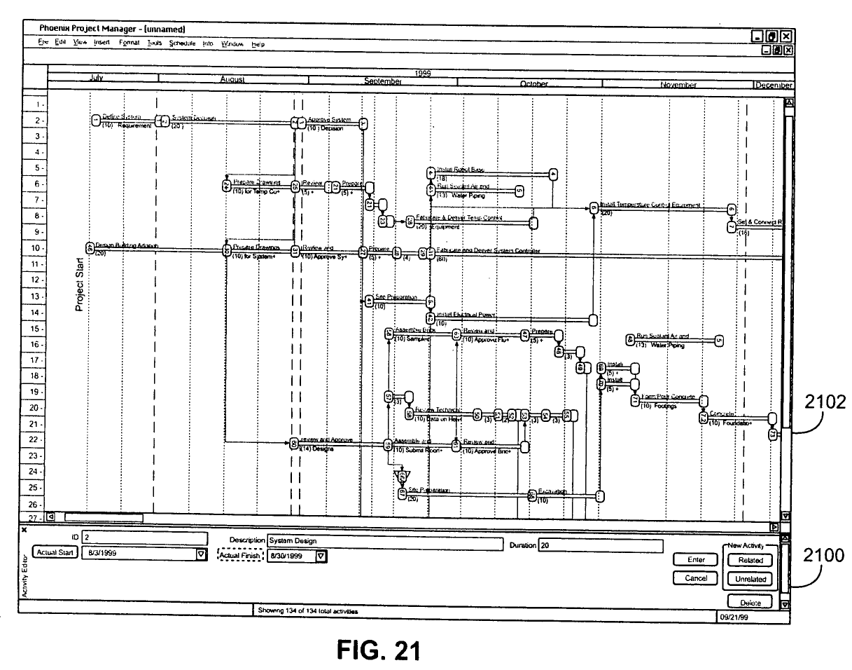

Referring to FIG. 21, an embodiment of an activity editor 2100 is shown below a network diagram 2102. The activity editor 2100 allows a user to manipulate data for a selected activity. A user may select an activity and then use the activity editor to adjust the activity as desired. An activity may also be manipulated by directly selecting an activity within the network diagram 2102 and editing description or identification. An activity may also have its duration manipulated by pointing and dragging the activity to a desired length relative to the time bar. The illustrated activity editor 2100 includes a relative small number of options which may be sufficient for a user.

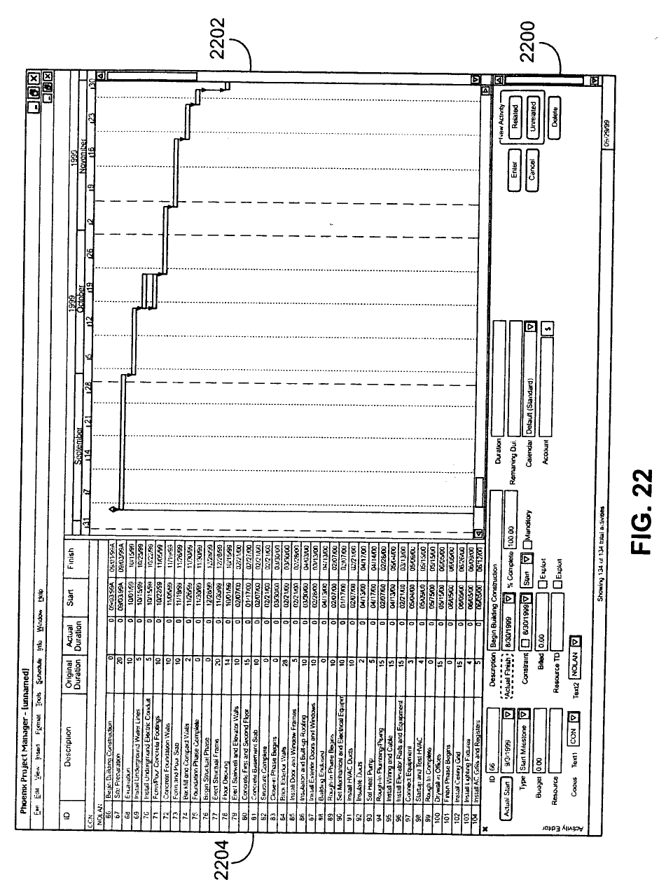

Referring to FIG. 22, an alternative embodiment of an activity editor 2200 is shown below a bar diagram 2202. An activity may be selected from the activity list 2204 for editing. The activity editor 2200 includes additional options for editing an activity. As can be appreciated, the activity editor 2200 can be customized in various ways as desired. The activity editor 2200 may also include default options for initial use.

The system and methods described herein provide network diagram capability to enhance user visualization of the entire project and manipulation of the activities. Activity editing may be performed through common user interface techniques. A CPM Checker evaluates activity information and assists a user in developing the schedule logic. The project management system and method may be used for a variety of complex projects throughout various industries.

It will be obvious to those having skill in the art that many changes may be made to the details of the above-described embodiments without departing from the underlying principles of the invention.

What is claimed is:

1. A method for diagramming a schedule for a project having a plurality of activities, comprising:
displaying the activities, each activity including a start tag, activity bar indicative of a duration, and a finish tag;
displaying a timeline simultaneously with displaying the activities;
linking the activities in finish-to-start, start-to-start, start-to-finish, and finish-to-finish relationships to thereby generate a network diagram of activities; and
displaying the activities in linked relationships with one another.

2. The method of claim 1, wherein each activity furthers include an activity description.

3. The method of claim 1, wherein each activity bar further includes a progress meter.

4. The method of claim 1, wherein linking the activities includes pointing and clicking on two activities using a mouse input device to thereby establish a link.

5. The method of claim 1, wherein linking the activities includes dragging activities into a desired position using a mouse input device.

6. The method of claim 1, further comprising:
selecting an activity in the network diagram through use of a mouse input device,
editing the activity through use of the mouse input device.

7. The method of claim 6, wherein editing the activity includes dragging the activity through use of the mouse input device to manipulate the length of the activity bar.

8. The method of claim 1, further comprising inserting text indicators into the network diagram.

9. The method of claim 1, further comprising:
assigning activities to a set,
associating an identification with the set,
allowing an option to select the set,
upon selection of the set, displaying the assigned activities.

10. A computer readable medium having stored thereon computer readable instruction code for performing a method for diagramming a schedule for a project having a plurality of activities, the method comprising:
displaying the activities, each activity including a start, activity bar indicative of a duration, and a finish;
editing the activities through use of a mouse input device;
displaying a timeline simultaneously with displaying the activities;
linking the activities to one another through use of a mouse input device to thereby generate a network diagram of activities;
displaying the activities in linked relationships with one another.

11. The computer readable medium of claim 10, wherein each activity furthers include an activity description.

12. The computer readable medium of claim 10, wherein each activity bar further includes a progress meter.

13. The computer readable medium of claim 10, wherein linking the activities includes dragging activities into a desired position using the mouse input device.

14. The computer readable medium of claim 10, wherein editing the activity includes dragging the activity through use of the mouse input device to manipulate the length of the activity bar.

15. The computer readable medium of claim 10, further comprising inserting text indicators into the network diagram.

16. The computer readable medium of claim 10, further comprising:
assigning activities to a set;
associating an identification with the set;
allowing an option to select the set; and
upon selection of the set, displaying the assigned activities.

17. A method for reviewing the logic of a schedule represented by a network diagram having a plurality of activities, the method comprising:
providing an interface to request parameters from a user;
receiving user entered parameters;
reviewing the network diagram to determine if the existence of a violation of the network schedule based on the parameters; and
displaying a violation message indicative of violation, the violation message indicating an element in the network schedule.

18. The method of claim 17 wherein the violation message includes an identification of the violation.

19. The method of claim 17, further comprising:
the violation message providing an option to recheck the violation, and
upon selection of the option, reviewing the network diagram to once again determine the existence of a violation.

20. The method of claim 17, further comprising:
the violation message providing an option to insert an explanation, and
upon selection of the option, generating an interface to receive a user-entered explanation.

21. The method of claim 17, further comprising:
the violation message providing an option to skip the violation; and
upon selection of the option, displaying a second violation message if a second violation exists.

22. The method of claim 17, further comprising:
the violation message providing an option to stop the review of the network diagram; and
upon selection of the option, terminating further generation of violation messages.

23. A computer readable medium having computer readable code stored thereon for performing a method for reviewing the logic of schedule represented by a network diagram having a plurality of activities, comprising:
providing an interface to request parameters from a user;
receiving user entered parameters;
reviewing the network diagram to determine if violations exist in the network schedule based on the parameters;
sequentially displaying violation messages, each violation message indicative of a corresponding violation and indicating an element in the network schedule that exceeds a parameter.

24. The method of claim 23 wherein each violation message includes an identification of the corresponding violation.

25. The method of claim 23, further comprising:
each violation message providing an option to recheck the corresponding violation, and
upon selection of the option, reviewing the network diagram to once again determine the existence of the corresponding violation.

26. The method of claim 23, further comprising:
each violation message providing an option to insert an explanation, and
upon selection of the option, generating an interface to receive a user-entered explanation.

27. The method of claim 23, further comprising,
each violation message providing an option to skip the violation, and
upon selection of the option, displaying the next violation message.

28. The method of claim 23, further comprising,
each violation message providing an option to stop the review of the network diagram, and
upon selection of the option, terminating further generation of violation messages.

29. A method for diagramming a schedule for a project having a plurality of activities, comprising:
generating a network of activities, each activity including a start, duration, and a finish;
generating a plurality of store points, each store point associated with a selected point in time, each store point indicating the position of each activity's start, duration, and finish in time; and
simultaneously displaying the activities for each store point in relation to one another to thereby provide a comparison.

30. The method of claim 29, further comprising selecting store points to be used in a simultaneous display of activities prior to simultaneously displaying the activities.

31. The method of claim 29, further comprising associating a color with each store point and wherein simultaneously displaying the activities for each store point includes displaying the activities in the associated color.

32. The method of claim 29, further comprising displaying a list of activities with simultaneously displaying the activities for each store point.

33. A computer readable medium having stored thereon computer readable instruction code for performing a method of diagramming a schedule for a project having a plurality of activities, comprising:
generating a network of activities, each activity including a start, duration, a finish, and a relation to another activity;
generating a plurality of store points, each store point associated with a selected point in time, each store point indicating the position of each activity's start, duration, and finish in time; and
simultaneously displaying the activities for each store point in relation to one another to thereby provide a comparison.

34. The computer readable medium of claim 33, further comprising selecting store points to be used in a simultaneous display of activities prior to simultaneously displaying the activities.

35. The computer readable medium of claim 33, further comprising associating a color with each store point and wherein simultaneously displaying the activities for each store point includes displaying the activities in the associated color.

36. The computer readable medium of claim 33, further comprising displaying a list of activities with simultaneously displaying the activities for each store point.

37. A method for providing a schedule for a project having a plurality of activities, comprising:
providing a calendar of days including work days and non-work days;
receiving user input for a first activity including a start date and a duration;
determining the finish date for the first activity based on the start date, duration, work days, and non-work days;
displaying the finish date and lag time created by non-work days.

38. The method of claim 37 further comprising:
linking the start date of a second activity to the finish date of the first activity; and
determining the start date for the second activity based on finish date of the first activity and lag time.

39. The method of claim 37 wherein displaying the finish date includes displaying a calendar with indicated start and finish dates.

40. A computer readable medium having stored thereon computer readable instruction code for performing a method for providing a schedule for a project having a plurality of activities, the method comprising:
providing a calendar including work days and non-work days;
receiving user input for activities, each activity including a duration;
linking the activities in relationships to one another;
determining lag time for the activities based on initial start dates, duration, work days, and non-work days; and
displaying a network of linked activities and durations including lag time.

41. A method for diagramming a schedule for a project having a plurality of activities, comprising:
providing an interface to customize an activity editor, the interface including a plurality of options;
receiving user selection of the options;
generating an activity editor that includes the selection of the options;
displaying the activity editor and a network diagram, the network diagram including a plurality of activities, each activity including a start, activity bar indicative of a duration, and a finish;
the activity editor receiving user input to select and edit an activity; and
the network diagram illustrating the edited activity in relation to the other activities.

42. The method of claim 41 further comprising displaying an activity list including an identification and description of each activity.

43. The method of claim 41, wherein each activity bar further includes a progress meter.

44. The method of claim 41, further comprising linking two activities displayed in the network diagram by pointing and clicking on the two activities using a mouse input device to establish a link.

45. The method of claim 41, further comprising:
selecting an activity in the network diagram through use of a mouse input device; and
editing the selected activity.

46. A computer readable medium having stored thereon computer readable instruction code for performing a method for diagramming a schedule for a project having a plurality of activities, the method comprising:
providing an interface to customize an activity editor, the interface including a plurality of options;
receiving user selection of the options;
generating an activity editor that includes the selection of the options;
displaying the activity editor and a network diagram, the network diagram including a plurality of activities, each activity including a start, activity bar indicative of a duration, and a finish;
the activity editor receiving user input to select and edit an activity; and
the network diagram illustrating the edited activity in relation to the other activities.

47. The computer readable medium of claim 46, further comprising displaying an activity list including an identification and description of each activity.

48. The computer readable medium of claim 46, wherein each activity bar further includes a progress meter.

49. The computer readable medium of claim 46, further comprising linking two activities displayed in the network diagram by pointing and clicking on the two activities using a mouse input device to establish a link.

50. The computer readable medium of claim 46, further comprising:
selecting an activity in the network diagram through use of a mouse input device; and
editing the selected activity.
